(19) United States
(12) Patent Application Publication
(10) Pub. No.: US 2015/0127557 A1
(43) Pub. Date: May 7, 2015

(54) CUSTOMER SERVICE SOFTWARE TO ANALYZE RISK AND PROFITABILITY AND MODIFY SCRIPTING IN REAL-TIME

(71) Applicant: Darryl Hicks, Plattsburgh, NY (US)

(72) Inventor: Darryl Hicks, Plattsburgh, NY (US)

(21) Appl. No.: 14/074,557

(22) Filed: Nov. 7, 2013

(51) Int. Cl. G06Q 30/00

(52) U.S. Cl. CPC G06Q 30/016
USPC 705/304

(57) ABSTRACT

A customer service software and related methods and systems can modify scripting in real-time based on the likelihood of customer fraud and/or profitability. The methods of the present invention analyze a plurality of different indicators of potential for risk, as well as a plurality of indicators for potential for long term profitability. Weights to these factors can be assigned and a weighted risk and profit score can be determined. Once determined, this weighted risk and profit score can be used to modify the customer service policies and scripting in real-time.

### BACKGROUND OF THE INVENTION

The present invention relates to customer service methods and systems and, more particularly, to a customer service software application and related methods and systems to modify scripting in real-time based on the likelihood of customer fraud and/or profitability.

Direct to consumer businesses that process payment where the customer is not physically present carry significant risk. Issuing too many refunds can destroy profitability, while not issuing enough can create reputational and financial risks.

Conventional customer service systems are often slow, with interfaces that are not intuitive for a call center agent. Many times, the agent has to refer to paper scripting or a separate computer system for scripting while using a customer relationship management (CRM) platform.

Conventional customer service systems require logins on a per-product basis. For a call center servicing multiple products, this can be quite cumbersome. Moreover, scripting is almost never combined with customer data and customer analysis.

As can be seen, there is a need for a customer service solution that can modify scripting based on customer risk and profitability.

### SUMMARY OF THE INVENTION

In one aspect of the present invention, a method for providing scripting for customer service agents comprises prompting the customer service agent to enter customer identification information into a computer-based interface; retrieving data from one or more underlying customer relationship management systems to determine a weighted risk score and a weighted profitability score for a customer; displaying customer data to the customer service agent on the computer-based interface; and displaying a script to the customer service agent on the computer-based interface which is updated, in real-time, based on the weighted risk score and the weighted profitability score.

In another aspect of the present invention, a method for providing scripting for customer service agents comprises logging into a single application to connect to a plurality of underlying customer relationship management systems;

prompting the customer service agent to enter customer identification information into a computer-based interface; retrieving data from one or more of the plurality of the underlying customer relationship management systems to determine a weighted risk score and a weighted profitability score for a customer; displaying customer data to the customer service agent on the computer-based interface;

displaying a script to the customer service agent on the computer-based interface which is updated, in real-time, based on the weighted risk score and the weighted profitability score; and logging interaction with the customer and storing interaction data locally and in the underlying customer relationship management system.

These and other features, aspects and advantages of the present invention will become better understood with reference to the following drawings, description and claims.

### BRIEF DESCRIPTION OF THE DRAWINGS

FIG. 1 is a flow chart showing a customer service method according to an exemplary embodiment of the present invention; and

FIG. 2 is an exemplary screen shot showing a color coded interface aside real-time updated scripts, according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a customer service software and related methods and systems that can modify scripting in real-time based on the likelihood of customer fraud and/or profitability. The methods of the present invention analyze a plurality of different indicators of potential for risk, as well as a plurality of indicators for potential for long term profitability. Weights to these factors can be assigned and a weighted risk and profit score can be determined. Once determined, this weighted risk and profit score can be used to modify the customer service policies and scripting in real-time. Unlike conventional customer service software that offers a one-size-fits-all approach to servicing customers, the software of the present invention can intelligently customize the approach to customer service in order to maximize profits while mitigating the majority of risks.

The software can retrieve the relevant customer data from an underlying repository (CRM) via a real-time application programming interface (API) and compares the data elements to a database table of known risk and profit scores. The API connectivity, linking to a variety of underlying CRM's, can provide customer service agents with a single point of login for all customers and products they service.

The various factors can be weighted by an administrator, for example, to best suit the needs of the business. In some embodiments, the weighting can vary on a product-by-product basis to arrive at the most relevant score possible. Rules can be created to determine what a customer service agent should do with each type of customer and appropriate scripting and color-coding of the interface can be provided to the agent. The result is a streamlined interface that is easy to read and uses and presents only the data the agent needs in order to service the customer properly. Highly detailed notes and logs on the outcome of the customer interaction are posted back to the underlying repository.

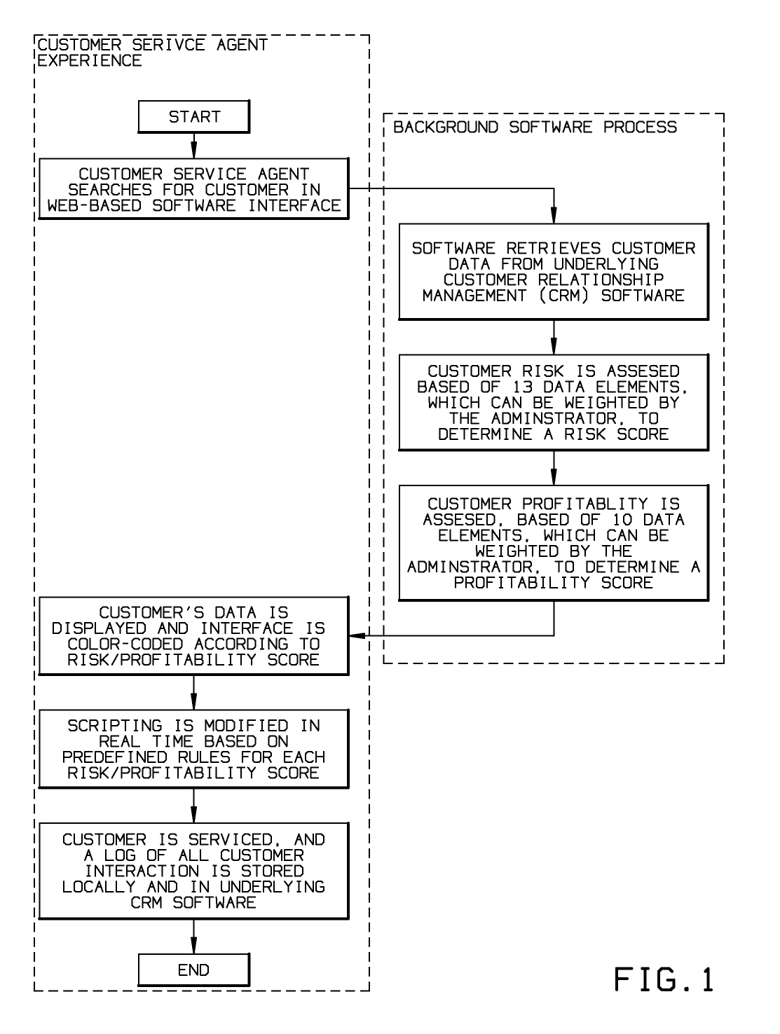

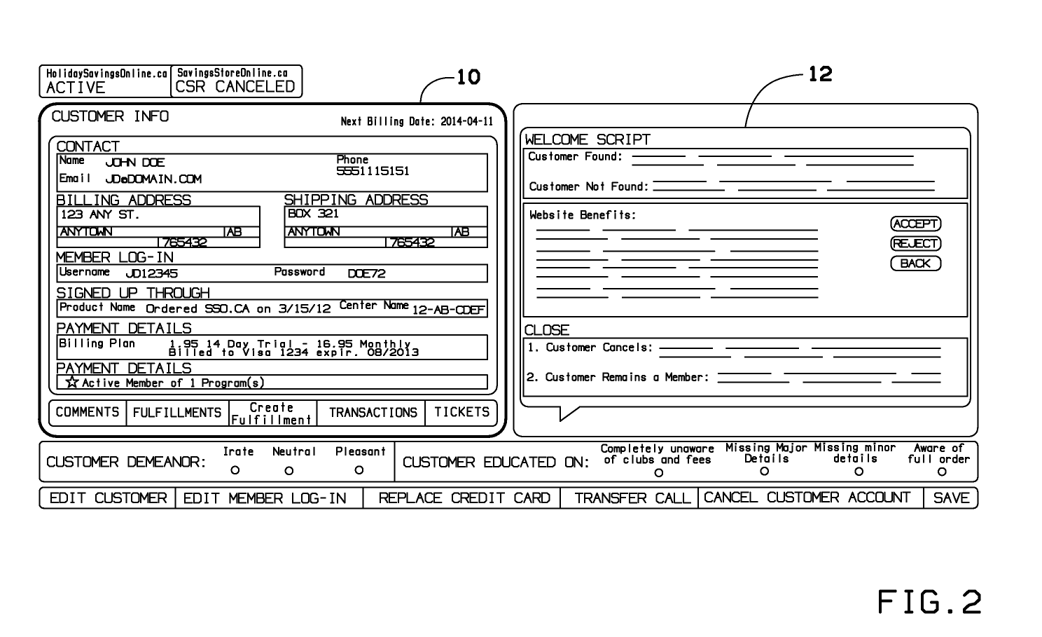

Referring now to FIGS. 1 and 2, a customer service agent can search for a customer in a software interface, such as a web-based software interface. In the background, the software retrieves customer data from underlying CRM software and customer risk is assessed based on a plurality of risk data elements that can be weighted by an administrator to determine a weighted risk score. The software also assesses customer profitability based on a plurality of profitability data elements that can be weighted by an administrator to determine a weighted profitability score.

The risk data elements and the profitability data elements can include the following: length of time active as a customer; card issuing bank and method of payment; area code, zip code and/or IP-geo location; method of customer acquisition; incentives used for sale; quality assurance (QA) rating; agent feedback from previous customer service calls; level of customer engagement with product; website logins; supplementary products ordered; customer service calls from the toll free number used on credit card statement; third party negative database match; and product price point (higher risk for higher price points, for example).

The weighted risk score and weighted profitability score can be used to determine the customer's propensity for profit or risk. An interface is provided to the customer service agent that is simple, elegant, color-coded and offers customized scripting, in real-time, based on the weighted risk and profitability scores.

The customer service agent can then service the customer according to their potential for risk and profitability. A log of all customer interaction can be stored locally and in the underlying CRM software.

The systems and software of the present invention can be used, for example, to determine whether or not a customer should even be offered a certain product at the point of acquisition. The logic could also be used in order to make automated customer services, such as interactive voice response (IVR), more effective.

It should be understood, of course, that the foregoing relates to exemplary embodiments of the invention and that modifications may be made without departing from the spirit and scope of the invention as set forth in the following claims.

What is claimed is:

1. A method for providing scripting for customer service agents, comprising:
prompting the customer service agent to enter customer identification information into a computer-based interface;
retrieving data from one or more underlying customer relationship management systems to determine a weighted risk score and a weighted profitability score for a customer;
displaying customer data to the customer service agent on the computer-based interface; and
displaying a script to the customer service agent on the computer-based interface which is updated, in real-time, based on the weighted risk score and the weighted profitability score.

2. The method of claim 1, wherein the customer identification information is a customer's name.

3. The method of claim 1, further comprising logging an interaction with the customer and storing interaction data locally and in the underlying customer relationship management system.

4. The method of claim 1, wherein the weighted risk score and the weighted profitability score have weights that vary according to a product or service that the customer seeks.

5. The method of claim 1, wherein weights for determining the weighted risk score and the weighted profitability score are adjustable to optimize customer risk and profitability.

6. The method of claim 1, wherein the weight risk score and the weighted profitability score are determined by a plurality of risk data elements and a plurality of profitability elements.

7. The method of claim 6, wherein the plurality of risk data elements and the plurality of profitability elements are selected from the group consisting of length of time active as a customer; card issuing bank and method of payment; area code, zip code or IP-geo location; method of customer acquisition; incentives used for sale; quality assurance rating; agent feedback from previous customer service calls; level of customer engagement with product; website logins;
supplementary products ordered; customer service calls from the toll free number used on credit card statement; third party negative database match; and product price point.

8. The method of claim 1, further comprising logging into a single site to connect to a plurality of underlying customer relationship management systems.

9. A method for providing scripting for customer service agents, comprising:
logging into a single application to connect to a plurality of underlying customer relationship management systems;
prompting the customer service agent to enter customer identification information into a computer-based interface;
retrieving data from one or more of the plurality of the underlying customer relationship management systems to determine a weighted risk score and a weighted profitability score for a customer;
displaying customer data to the customer service agent on the computer-based interface;
displaying a script to the customer service agent on the computer-based interface which is updated, in real-time, based on the weighted risk score and the weighted profitability score; and
logging an interaction with the customer and storing interaction data locally and in the underlying customer relationship management system.

10. The method of claim 9, wherein the weight risk score and the weighted profitability score are determined by a plurality of risk data elements and a plurality of profitability elements, wherein the plurality of risk data elements and the plurality of profitability elements are selected from the group consisting of length of time active as a customer; card issuing bank and method of payment; area code, zip code or IP-geo location; method of customer acquisition; incentives used for sale; quality assurance rating; agent feedback from previous customer service calls; level of customer engagement with product; website logins; supplementary products ordered; customer service calls from the toll free number used on credit card statement; third party negative database match; and product price point.
